(19) United States
(12) Patent Application Publication
(10) Pub. No.: US 2008/0013589 A1
(43) Pub. Date: Jan. 17, 2008

(54) Window assembly for a gas discharge laser chamber

(75) Inventors: John T. Melchior, San Diego, CA (US); Richard C. Ujazdowski, Poway, CA (US); James K. Howey, Vista, CA (US)

Correspondence Address: Matthew K. Hillman;Cymer, Inc., Legal Dept., MS/4-2C, 17075 Thornmint Court, San Diego, CA, 92127-2413, US

(73) Assignee: Cymer, Inc., San Diego, CA (US)

(21) Appl. No.: 11/488,879

(22) Filed: Jul. 17, 2006

(51) Int. Cl. H01S 3/08

(52) U.S. Cl. 372/103

(57) ABSTRACT

A window assembly for a pressurized laser discharge chamber is disclosed and may include a housing that is formed with a recess. The assembly may also include an optic having a first side that is exposed to chamber pressure and an opposed second side, and a compliant member that may be positioned in the recess to space the second side of the optic from the housing under normal chamber operating pressures. For the assembly, the compliant member may be compressible to allow the optic to mechanically abut the assembly housing during a chamber overpressure.

### FIELD OF THE INVENTION

The present invention relates generally to gas discharge laser systems. The present invention is particularly, but not exclusively useful as a window assembly for a gas discharge laser chamber.

### BACKGROUND OF THE INVENTION

A typical gas discharge laser may employ a pair of spaced apart, elongated discharge electrodes to initiate lasing in a gaseous material. In one arrangement, a two-piece chamber may be employed that envelops the gaseous gain media and the discharge region. At each end of the chamber, a pair of opposed windows are typically provided to contain the gas in the chamber and allow light to enter and exit the discharge region.

Some modern lasers use discharge gases which are somewhat toxic such as KrF, XeF, XeCl, ArF, F₂, etc. and can be corrosive. If these gases leak or are suddenly, uncontrollably released from the chamber, they may cause damage to other laser system components and pose a potential health hazard. In more advanced laser systems, the laser gas(ses) may be introduced, either continuously or intermittently during laser operation to replenish the active components of the laser medium. Although these systems typically incorporate safety components, e.g., regulators, check valves, etc., to prevent overpressurization of the chamber (i.e., pressures higher than the normal specified chamber operating range), safety considerations typically dictate that the laser windows be capable of withstanding a reasonable overpressurization without leakage or catastrophic failure. For some types of lasers, e.g., pulsed excimer lasers, pulse energy can be increased by increasing the pressure of the gaseous gain media. As a consequence, there has been a trend toward higher chamber pressures, which in turn, has placed additional stresses on the chamber window assemblies.

In addition to withstanding a reasonable overpressure without leaking or failure, the window assemblies must perform their optical function of transmitting the laser light with little or no distortion. For laser systems which produce light at relatively short wavelengths, e.g., ArF lasers at 193 nm, the choice of window materials is somewhat limited. For example, and not by way of limitation, CaF₂, has been used somewhat exclusively as a window material in ArF lasers. One problem associated with CaF₂ windows has been the undesirable formation of optical defects due to so-called slip plane damage that may occur when portions of the window are exposed to localized stress concentrations. These stress concentrations can occur, for example, when the CaF₂ window is mounted against a hard surface containing minor surface asperities.

With the above considerations in mind, Applicants disclose a window assembly for a gas discharge laser chamber.

### SUMMARY OF THE INVENTION

In a first aspect of an embodiment of the invention, a window assembly for a pressurized laser discharge chamber may comprise a housing that is formed with a recess, an optic, e.g., a CaF₂ flat, having a first side that is exposed to chamber pressure and an opposed second side, and a compliant member that may be positioned in the recess to space the second side of the optic from the housing under operating chamber pressures. For this aspect, the compliant member may be compressible to allow the optic to mechanically abut the assembly housing during a chamber overpressure.

In one embodiment the recess may be shaped as an annular channel and in a particular embodiment the compliant member may comprise a metal disc spring. In one arrangement, a rigid pad, may be interposed between the optic and housing to distribute load during the mechanical abutment. The pad may be, for example, a metallic sheet, e.g., copper, formed with an aperture to allow for light passage. A second compliant member, e.g., an elastomeric O-ring may be provided that is interposed between the first side of the optic and the housing to space the first side from the housing, and in some cases, a UV shield may be positioned between the O-ring and optic.

In another aspect, a window assembly for a pressurized laser discharge chamber may comprise a housing, an optic having a first side exposed to chamber pressure and an opposed second side, and a member disposed between the housing and optic, the member being reconfigurable in response to an increase in chamber pressure from a first configuration wherein the second side of the optic is spaced from the housing and a second configuration wherein the second side of the optic and housing are mechanically abutted. For this aspect, the compliant member may be, but is not necessarily limited to, a metal disc spring, a compressible C ring or an elastomeric O-ring. In one implementation, a rigid pad may be interposed between the optic and housing to distribute load during the mechanical abutment. In one embodiment the assembly may comprise a second compliant member interposed between the first side of the optic and the housing to space the first side from the housing and in a particular embodiment the second compliant member may be an elastomeric O-ring and the assembly may further comprise a UV shield positioned between the O-ring and-optic.

In a particular aspect, a window assembly for a pressurized laser discharge chamber may comprise a housing, an optic having a first side exposed to chamber pressure and an opposed second side, a compliant member disposed between the housing and optic to space the second side of the optic from the housing at operating chamber pressures, and a rigid pad interposed between the optic and compliant member to abut against the housing and reduce mechanical stress on the optic during a chamber overpressure. For example, the assembly may be configured such that the operating chamber pressure is in the range of 200 to 500 kPa and the abutment occurs at a chamber overpressure in the range of 600 to 700 kPa. In some cases, the compliant member may establish a fluid-tight seal between the optic and housing and for some types of compliant members, e.g., elastomeric O-rings, the assembly may further comprise a UV shield reducing exposure of the compliant member to UV light scattered by the optic.

### BRIEF DESCRIPTION OF THE DRAWINGS

FIG. 1 shows a simplified, perspective, partially exploded view of portions of a gas discharge laser having a chamber and two window assemblies;

FIG. 2 is an exploded perspective view of a window assembly;

FIG. 3A is a cross sectional view of a window assembly as seen along line 3A-3A in FIG. 2, shown with the window assembly exposed to normal operating chamber pressure;

FIG. 3B is a cross sectional view of a window assembly as seen along line 3A-3A in FIG. 2, shown with the window assembly exposed to an overpressure; and

FIG. 4 is a cross sectional view as in FIG. 2 of another embodiment of a window assembly.

### DETAILED DESCRIPTION OF PREFERRED EMBODIMENTS

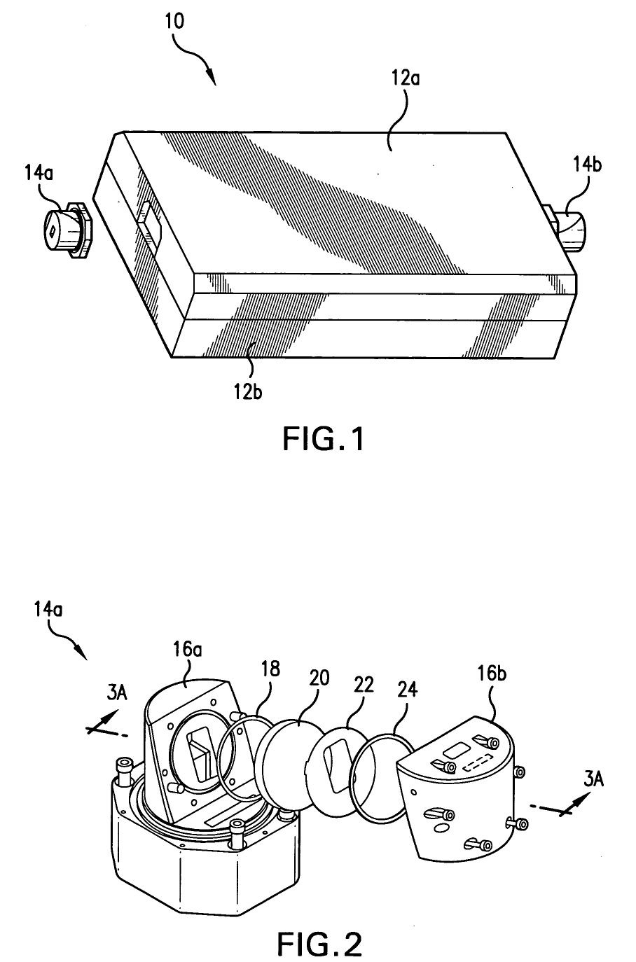

Referring initially to FIG. 1, portions of a gas discharge laser, such as a KrF excimer laser, an XeF excimer laser, an XeCl excimer laser, an ArF excimer laser or molecular fluorine laser are shown and generally designated 10. As shown, the laser 10 typically includes a hollow, two-part chamber 12a,b that may be made of a conductive, corrosion resistant material, e.g., nickel-plated aluminum, and is generally rectangular in construction. Also shown in FIG. 1, window assemblies 14a,b may be provided at each end of the chamber 12a,b to allow light to enter, exit and pass through the chamber 12a,b while containing the gas in the chamber 12a,b. With this structure, the chamber 12a,b and window assemblies 14a,b may surround a volume which holds a laserable gas medium under pressure together with other components suitable to create discharge in the medium, e.g., discharge electrodes (not shown), a fan to circulate the gas (not shown) heat exchanges to cool the gas (not shown), etc., It is to be appreciated that the chamber 12a,b may also be formed with a number of sealed inlets/outlets, to allow gas to be introduced/extracted from the chamber, to allow conductors to deliver an excitation voltage to the electrodes, etc. (note: inlets/outlets not shown in an effort to simplify FIG. 1).

FIG. 2 shows a window assembly 14a in greater detail. As seen there, the window assembly 14a may include a two part housing 16a,b, which may be machined from metal and when assembled together may be rigidly attached, e.g., via screws, to the chamber 12a. FIG. 2 also shows that the window assembly 14a may include an O-ring 18 which may be made from an elastomeric material, e.g., rubber or synthetic rubber. Continuing with FIG. 2, the assembly 14a may include an optic 20, made of a material selected to be transparent to the particular wavelength(s) of coherent light generated by the laser and compatible with the gaseous laser medium. For example, the optic 20 may be a CaF₂ flat for use with an ArF laser. As shown, the assembly may also include a pad 22 and a disc spring 24. For example, the pad may be 0.1-0.3 mm thick stamped copper sheet and the disc spring may be made of metal.

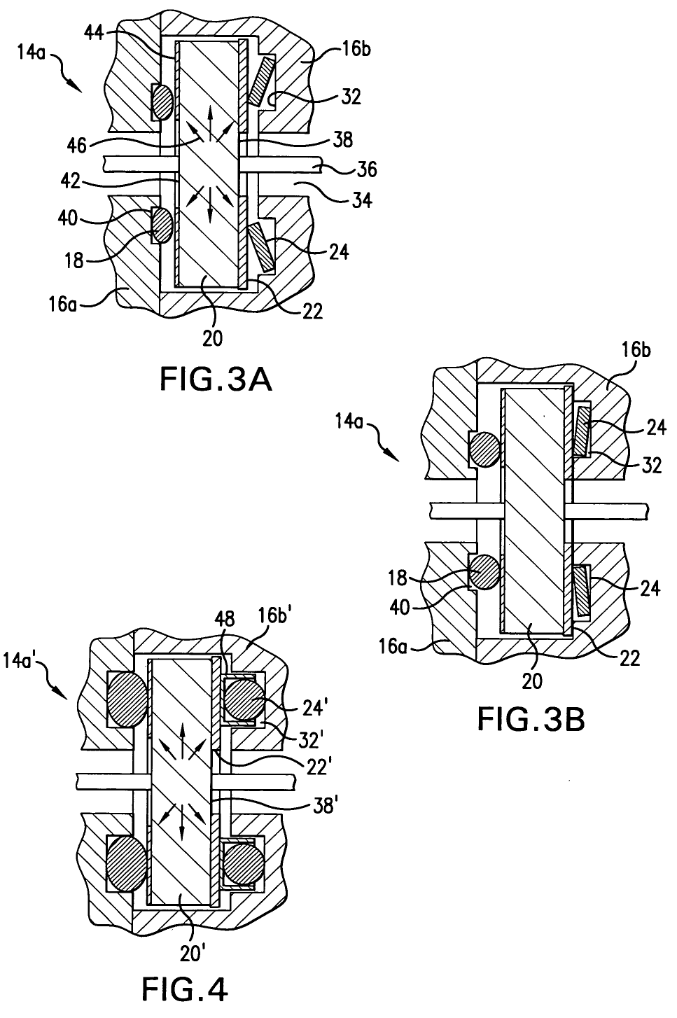

The cooperative interaction of the window assembly components 16a, 16b, 18, 20, 22 and 24, may best be understood with initial cross reference to FIGS. 2 and 3A. Specifically, as best seen in FIG. 3A, the housing 16b may be formed with a recess 32 (which for the embodiment shown may be shaped as a square annular channel) that surrounds an aperture 34 in the housing through which a light beam 36 may travel. FIG. 3A further shows that a compliant member (which for the embodiment shown may be a disc spring 24) may be partially disposed in the recess 32. Under normal operating chamber pressures, as shown in FIG. 3A, the disc spring 24 may be in a partially deformed state, and, in this state, may space the side 38 of the optic 20 from the housing 16b and provide a seal between the optic 20 and the housing 16b. With the optic 20 held by the compliant member in this manner, localized stresses on the optic 20 may be reduced as compared with an optic that is mounted directly against a housing or other surface which may contain surface asperities.

FIG. 3A further shows that a second compliant member (which for the embodiment shown may be an elastomeric O-ring 18 may be partially disposed in a recess 40 formed in the housing 16a. With this structural arrangement, the O-ring 18 may be interposed between the side 42 of the optic 20 and the housing 16a to space the side 42 from the housing 16a. As shown, the O-ring 18 may provide a contact point directly opposite the contact point established by the disc spring 24 to reduce stresses on the optic 20. A UV shield (which for the embodiment shown may be a metallic coating 44 on the optic 20, e.g., 0.3 μm of aluminum, forming an annular band surrounding a central portion of the optic 20. With this arrangement, the UV shield may be positioned between the O-ring 18 and optic 20 to reduce exposure of the O-ring 18 (which may be UV sensitive) to scattered UV radiation (illustrated by arrow 46).

FIG. 3B shows the window assembly 14a when exposed to a chamber overpressure. As shown there, the overpressure may translate the optic 20 toward the housing 16b compressing the compliant member (disc spring 24) into the recess 32 (either partially or fully) and allowing the optic 20 to mechanically abut the housing 16b. Note: as used herein, the term “mechanically abut” does not necessarily imply that direct contact is required for two elements to mechanically abut. Instead, as shown in FIGS. 2 and 3B, another element, e.g., a rigid or fully compressed element, (in this case pad 22) may be interposed between the optic 20 and housing 16b when the optic 20 mechanically abuts the housing 16b. The pad 22 may function to distribute load during normal operation (e.g. when the chamber is at operating pressures and below) and during the mechanical abutment and may reduce the amount of bowing experienced by the optic (as compared with an arrangement without the pad 22). As further shown in FIG. 3B, the recess 40 and O-ring may be sized such that the O-ring remains in compression during mechanical abutment of the optic 20 and the housing 16b. Thus, the chamber may remain sealed during an overpressure.

FIG. 4 shows another embodiment of a window assembly that is designated generally 14a′. For this embodiment, a compliant member (which for the embodiment shown may be an O-ring 24′, e.g., made of a compressible, elastomeric material, e.g., rubber or synthetic rubber) may be partially disposed in the recess 32′. Under normal operating chamber pressures, as shown in FIG. 4, the O-ring 24′ may be in a partially deformed state, and, in this state, may space the side 38′ of the optic 20′ from the housing 16b′ and provide a seal between the optic 20′ and the housing 16b′. With the optic 20′ held by the compliant member in this manner, localized stresses on the optic 20′ may be reduced as compared with an optic that is mounted directly against a housing or other surface which may contain surface asperities.

Unlike the metal disc spring 24 used in the embodiment shown in FIG. 2, the O-ring 24′ may be susceptible to UV exposure damage. FIG. 4 further shows that a UV shield (which for the embodiment shown is an annular ring 48 having a square channel cross section and made of a material, e.g., aluminum, which reduces exposure of the O-ring 24′ to UV radiation scattered by the optic 20′) may be interposed between the optic 20′ and O-ring 24′. For this embodiment, the ring 48 may or may not be affixed to, or integral with, the pad 22′. As shown, the width of the channel of the ring 48 may be sized to allow the O-ring 24′ to compress during an overpressurization and allow the pad 22′ to contact the housing 16b′ when the optic 20′ mechanically abuts the housing 16b′.

Although a metallic disc spring and elastomeric O-ring have been described heretofore, it is to be appreciated that other types of compliant members may be used in the window assemblies covered herein including elastomeric disc springs, rings having other than O-ring cross-sections, e.g., C—seals, metallic or elastomeric and wave springs.

While the particular aspects of embodiment(s) described and illustrated in this patent application in the detail required to satisfy 35 U.S.C. §112 is fully capable of attaining any above-described purposes for, problems to be solved by or any other reasons for or objects of the aspects of an embodiment(s) above described, it is to be understood by those skilled in the art that it is the presently described aspects of the described embodiment(s) of the present invention are merely exemplary, illustrative and representative of the subject matter which is broadly contemplated by the present invention. The scope of the presently described and claimed aspects of embodiments fully encompasses other embodiments which may now be or may become obvious to those skilled in the art based on the teachings of the Specification. The scope of the present invention is solely and completely limited by only the appended Claims and nothing beyond the recitations of the appended Claims. Reference to an element in such Claims in the singular is not intended to mean nor shall it mean in interpreting such Claim element “one and only one” unless explicitly so stated, but rather “one or more”. All structural and functional equivalents to any of the elements of the above-described aspects of an embodiment(s) that are known or later come to be known to those of ordinary skill in the art are expressly incorporated herein by reference and are intended to be encompassed by the present Claims. Any term used in the Specification and/or in the Claims and expressly given a meaning in the Specification and/or Claims in the present Application shall have that meaning, regardless of any dictionary or other commonly used meaning for such a term. It is not intended or necessary for a device or method discussed in the Specification as any aspect of an embodiment to address each and every problem sought to be solved by the aspects of embodiments disclosed in this Application, for it to be encompassed by the present Claims. No element, component, or method step in the present disclosure is intended to be dedicated to the public regardless of whether the element, component, or method step is explicitly recited in the Claims. No claim element in the appended Claims is to be construed under the provisions of 35 U.S.C. §112, sixth paragraph, unless the element is expressly recited using the phrase “means for” or, in the case of a method claim, the element is recited as a “step” instead of an “act”.

It will be understood by those skilled in the art that the aspects of embodiments of the present invention disclosed above are intended to be preferred embodiments only and not to limit the disclosure of the present invention(s) in any way and particularly not to a specific preferred embodiment alone. Many changes and modification can be made to the disclosed aspects of embodiments of the disclosed invention(s) that will be understood and appreciated by those skilled in the art. The appended Claims are intended in scope and meaning to cover not only the disclosed aspects of embodiments of the present invention(s) but also such equivalents and other modifications and changes that would be apparent to those skilled in the art.

What is claimed is:

1. A window assembly for a pressurized laser discharge chamber, the assembly comprising:
a housing formed with a recess;
an optic having a first side exposed to chamber pressure and an opposed second side;
a compliant member partially disposed in said recess spacing the second side of the optic from the housing under operating chamber pressures and compressible to allow the optic to mechanically abut the housing during a chamber overpressure.

2. An assembly as recited in claim 1 wherein the recess is shaped as an annular channel.

3. An assembly as recited in claim 1 wherein the optic comprises CaF₂.

4. An assembly as recited in claim 1 wherein the compliant member comprises a metal disc spring.

5. An assembly as recited in claim 1 further comprising a rigid pad interposed between the optic and housing to distribute load during the mechanical abutment.

6. An assembly as recited in claim 5 wherein the pad is made of copper.

7. An assembly as recited in claim 1 further comprising a second compliant member interposed between the first side of the optic and the housing to space the first side from the housing.

8. An assembly as recited in claim 7 wherein the second compliant member is an elastomeric O-ring.

9. An assembly as recited in claim 8 further comprising a UV shield positioned between the O-ring and optic.

10. An assembly as recited in claim 9 wherein the UV shield comprises a metallic coating formed on portions of the optic.

11. A window assembly for a pressurized laser discharge chamber, the assembly comprising:
a housing;
an optic having a first side exposed to chamber pressure and an opposed second side;
a member disposed between the housing and optic and reconfigurable in response to an increase in chamber pressure from a first configuration wherein the second side of the optic is spaced from the housing and a second configuration wherein the second side of the optic and housing are mechanically abutted.

12. An assembly as recited in claim 11 wherein the compliant member is selected from the group of compliant elements consisting of a metal disc spring, a compressible C ring and an elastomeric O-ring.

13. An assembly as recited in claim 11 further comprising a rigid pad interposed between the optic and housing to distribute load during the mechanical abutment.

14. An assembly as recited in claim 11 further comprising a second compliant member interposed between the first side of the optic and the housing to space the first side from the housing.

15. An assembly as recited in claim 14 wherein the second compliant member is an elastomeric O-ring and the assembly further comprises a UV shield positioned between the O-ring and optic.

16. A window assembly for a pressurized laser discharge chamber, the assembly comprising:
a housing;
an optic having a first side exposed to chamber pressure and an opposed second side;
a compliant member disposed between the housing and optic to space the second side of the optic from the housing at operating chamber pressures; and
a rigid pad interposed between the optic and member to abut against the housing and reduce mechanical stress on the optic during a chamber overpressure.

17. A window assembly as recited in claim 16 wherein the operating chamber pressure is in the range of 200 to 500 kPa and the chamber overpressure is in the range of 600 to 700 kPa.

18. A window assembly as recited in claim 16 wherein the rigid pad comprises a metallic sheet formed with an aperture to allow light to pass through.

19. A window assembly as recited in claim 16 wherein the compliant member establishes a fluid-tight seal between the optic and housing.

20. A window assembly as recited in claim 16 further comprising a UV shield reducing exposure of the compliant member from UV light scattered by the optic.
